(19) United States
(12) Patent Application Publication
(10) Pub. No.: US 2010/0176766 A1
(43) Pub. Date: Jul. 15, 2010

(54) CONTROL METHOD FOR AN ACCUMULATOR BATTERY AND A HAND POWER TOOL

(75) Inventors: Michael BRANDNER, Buchloe (DE); Thomas MUELLER, Klosterlechfeld (DE); Roland SCHWAB, Geltendorf (DE); Bernd ZIEGLER, Hiltenfingen (DE); Klaus HAUSER, Schwabmuenchen (DE)

Correspondence Address: CROWELL & MORING LLP;INTELLECTUAL PROPERTY GROUP, P.O. BOX 14300, WASHINGTON, DC, 20044-4300, US

(73) Assignee: Hilti Aktiengesellschaft, Schann (LI)

(21) Appl. No.: 12/683,708

(22) Filed: Jan. 7, 2010

(30) Foreign Application Priority Data
Jan. 9, 2009 (DE) 10 2009 000 102.6

(51) Int. Cl. H02J 7/00; B25F 5/00

(52) U.S. Cl. 320/136; 173/217; 320/135

(57) ABSTRACT

A control method for a system of a hand power tool and an accumulator battery is disclosed. The hand power tool is connectable to the accumulator battery via a current interface for supplying the hand power tool. The hand power tool features a data interface for communicating with the accumulator battery. Characterizing data of the hand power tool and/or data about an operating process of the hand power tool is transmitted to the accumulator battery via the interface.

This application claims the priority of German Patent Document No. 10 2009 000 102.6, filed Jan. 9, 2009, the disclosure of which is expressly incorporated by reference herein.

### BACKGROUND AND SUMMARY OF THE INVENTION

The present invention relates to a control method for an accumulator battery and a hand power tool, and a system of an accumulator battery and a hand power tool.

Power is increasingly supplied to hand power tools by accumulator batteries, e.g., lithium-ion accumulator batteries. The power output from the accumulator batteries must be controlled in order to avoid damage to the accumulator batteries e.g., due to a total discharge.

The requirements and load profiles of various hand power tools for the accumulator batteries differ very greatly. In addition, requirements also differ by field of application.

One objective is making available a system of a hand power tool and an accumulator battery in which an optimal utilization of an accumulator battery is possible, which can be used for different hand power tools.

This objective is attained by the control method and the system of hand power tool and accumulator battery according to the invention.

The control method for an accumulator battery according to the invention, which features an interface for communicating with a hand power tool and for supplying the hand power tool, provides for the accumulator battery to receive data characterizing the hand power tool and/or data about an operating process of the hand power tool via the interface.

The control method for a hand power tool according to the invention, which features an interface for communicating with an accumulator battery and for supplying via the accumulator battery provides that the data characterizing the hand power tool and/or data about an operating process of the hand power tool are output via the interface.

The control method for a system of a hand power tool and an accumulator battery according to the invention, wherein the hand power tool is connectable to the accumulator battery via a current interface for supplying the hand power tool, and the hand power tool features a data interface for communicating with the accumulator battery, provides that data characterizing the hand power tool are transmitted to the accumulator battery and/or data about an operating process of the hand power tool.

The hand power tool informs the accumulator battery about the typical application profile. The accumulator battery can hereby optimize its switch-off. Strict switch-off criteria, which cover all possible application fields of an accumulator battery, can be overridden or adapted to the application or the hand power tool.

The characterizing data may include a load profile of the hand power tool, e.g., characterizing data about a voltage limit of the accumulator battery and/or maximum permissible duration, for which a voltage limit of the accumulator battery may be fallen short of. The characterizing data may be read out of a permanent memory of the hand power tool.

One embodiment provides that characterizing data about the voltage limit and/or a maximum permissible duration for which a voltage limit of the accumulator battery may be fallen short of are received/transmitted via the interface. If a total discharge protection of the accumulator battery determines that the voltage limit has been fallen short of longer than the maximum permissible duration, a warning signal is output to the hand power tool via the interface and/or a power supply via the interface is interrupted on the part of the accumulator battery. If a warning signal of a total discharge protection that the voltage limit has been fallen short of longer than the maximum permissible duration is received by the hand power tool via the interface, the hand power tool switches off its motor.

A recording device of the hand power tool may log an operation of the hand power tool and transfer the logged data to the accumulator battery for storage in the accumulator battery. The logged data may be transmitted for example if the system switch is not actuated for longer than a predetermined period of time.

An accumulator battery, a hand power tool and the system of accumulator battery and hand power tool are set up to execute the described method.

The following description explains the invention on the basis of exemplary embodiments and FIGURE.

### BRIEF DESCRIPTION OF THE DRAWING

FIG. 1 illustrates a hand power tool having an accumulator battery.

### DETAILED DESCRIPTION OF THE DRAWING

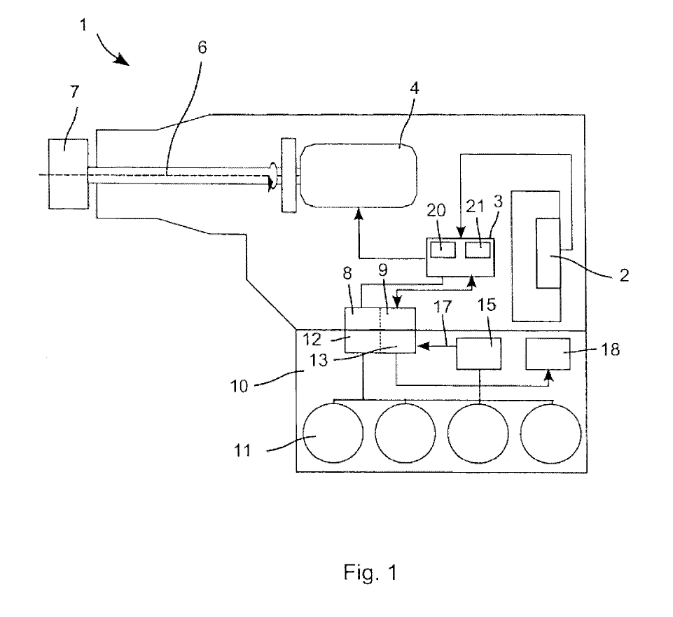

FIG. 1 depicts a battery-operated standard power screwdriver 1 as an example of a hand power tool. A user may actuate a system switch 2, whereupon a system control 3 is activated. The system control 3 turns on a motor 4, which rotates a drive train 6 and a tool receptacle 7, for example, for a wrench socket or bit. The system control 3 stops the motor 4 when the user lets go of the system switch 2. The duration for which the motor 4 is turned on will be designated in the following as the active phase of the power screwdriver 1. The active phase may depend upon the field of application of the standard power screwdriver 1. In a typical application, the active phase is 2 sec to 6 sec long for example.

Power is supplied to the hand power tool 1 via a chargeable accumulator battery 10. Current interfaces 8, 12 that correspond to each other are provided in the hand power tool 1 and the accumulator battery 10. The accumulator battery 10 may be a lithium-ion accumulator battery with a plurality of cells 11 for example.

The accumulator battery 10 features an electrical capacity and a state of charge. In an active phase the hand power tool 1 discharges the accumulator battery 10. The accumulator battery 10 may not be discharged below a minimum state of charge, because this could lead to permanent damage to the accumulator battery. A further discharging is designated as a total discharge. The accumulator battery 10 signals a warning signal 17 via a data interface 9, 13 to the hand power tool 1 if a total discharge protection 15 of the accumulator battery 10 detects a total discharge. Responding to the warning signal 17, the hand power tool 1 prematurely terminates the active phase and switches the motor 4 off.

The warning signal 17 can be transmitted to the hand power tool 1 as a clearly identifiable signal. Alternatively, error and warning messages of the accumulator battery 10 can be combined into a status signal, if need be, a single unit of information. Further warning messages can relate for example to exceeding a permissible operating temperature of the accumulator battery 10.

The first indication of a total discharge is the terminal voltage of the accumulator battery 10 dropping below a voltage limit of the accumulator battery 10. Under load, the terminal voltage can drop below the voltage limit. However, if the accumulator battery is not loaded, the terminal voltage can rise again and therefore reach a value above the voltage limit. Therefore, a total discharge can only be detected reliably under load on the basis of the terminal voltage, i.e., during the active phase.

However, falling short of the voltage limit can also occur based on a short-term peak load instead of a total discharge. As soon as the load from the peak load drops to an average level, the terminal voltage again rises above the voltage limit even with continued average load. Falling short of the voltage limit in the short-term is therefore not an indication of a damaging total discharge but only an indication of a high mechanical load of the hand power tool 1.

Peak loads can occur with the standard power screwdriver, for example, when loosening a tight screw. This situation can last, for example, 1 sec to 2 sec. In the event of such a load, the terminal voltage of the accumulator battery 10 can drop below the voltage limit without being totally discharged for a duration of 1 sec to 2 sec. Switching off the standard power screwdriver is not desired in this case. As a result, it is provided that the terminal voltage may fall below the voltage limit for the typical duration of 1 sec to 2 sec with an accumulator battery attached to the standard power screwdriver without a total discharge being signaled to the power tool 1.

However, falling short of the voltage limit cannot generally be tolerated for 1 sec to 2 sec. Drywall power screwdrivers are an example of this. Drywall power screwdrivers are power screwdrivers that have been specially adapted to the requirements for drywall; among other things, the drywall power screwdrivers can be equipped with magazines for feeding screws. Their power consumption and load profiles may differ from those of the standard power screwdriver. The placement duration for a screw in drywall, i.e., the active phase, typically averages between 0.2 sec and 1 sec, e.g., 0.5 sec. The active phase is consequently too short for a falling short of the voltage limit of 1 sec to 2 sec to occur. As a result, it is provided that a drywall power screwdriver define the permissible duration of falling short of the voltage limit as another value, which is shorter than its active phase, e.g., to 80% to 90% of the typical active phase.

The hand power tool 1 features a memory 20, in which the permissible duration T for which the voltage limit may be fallen short of is stored. The permissible duration can be specified depending upon the type or the application area of the hand power tool 1. The memory can be a permanent memory, wherein the permissible duration is defined during the manufacturing of the hand power tool 1. The maximum permissible duration T can be defined as a function of the expected average duration of its active phases. For example, the maximum permissible duration T can be between 50% and 90% of the active phase. For hand power tools 1, which have a comparatively long active phase, e.g., circular hand saws of 1 min to 2 min, alternatively or additionally, an upper limit of the maximum permissible duration T can be specified as 2 sec to 5 sec.

The monitoring of a total discharge may take place by the total discharge protection 15 in the accumulator battery 10. The voltage limit can be specified and monitored for the entire accumulator battery 10 or for each of its individual cells 11. Alternatively or additionally, a total discharge can be monitored by a total discharge protection in the system control 3.

The total discharge protection 15 is triggered if a terminal voltage of the accumulator battery 10 falls below the voltage limit. The total discharge protection 15 waits for a first period of time T. If the terminal voltage remains under the voltage limit for the duration of the first period of time T, the accumulator battery 10 is disconnected from the hand power tool 1. In one embodiment, the total discharge protection transmits a warning signal via the data interface to the hand power tool. In response to the warning signal, a control device of the hand power tool deactivates the current interface and/or switches the motor 4 off. Alternatively or additionally, the accumulator battery 10 can deactivate the current interface 12.

If the terminal voltage within the first period of time T again rises above the voltage limit, the total discharge protection 15 will be deactivated. Thus, the first period of time T specifies a duration for which falling short of the voltage limit is permissible, i.e., the accumulator battery 10 or the motor 4 will not be switched off.

The first period of time T or the maximum permissible duration is transmitted by the hand power tool 1 to the accumulator battery 10 every time it is started up. The maximum permissible duration T can be stored in the hand power tool 1 in the memory 20. A data interface 13 in the hand power tool 1 and a corresponding data interface 9 in the accumulator battery 10 are provided for the transmission of the maximum permissible duration T.

The hand power tool 1 can additionally transmit ratings for a typical load via the data interface 9 to the accumulator battery 10. The ratings include, for example, the power consumption during an active phase T or peak loads that occur during an active phase. The average ratings can be stored in the memory 20 of the hand power tool 1. For example, a voltage drop that occurs during the typical operation of charged accumulator batteries 10 can be stored. In the event of a voltage drop, the total discharge protection 15 can check whether this voltage drop is greater than the voltage drop transmitted by the hand power tool 1. This would be an indication of a total discharge. In this case, the motor 4 is switched off and/or the current interface 12 is deactivated and the accumulator battery 10 is disconnected electrically from the hand power tool 1.

The hand power tool 1 may feature a recording device 21. The recording device 21 counts the number of active phases during an operating cycle. An operating cycle can be terminated if the user lets go of the system switch 2. Alternatively, the operating cycle can be continued, if the user again actuates the system switch 2 within a predetermined period of time.

The recording device 21 can record, volatilely or non-volatilely, the operating duration and/or data concerning power consumption from the accumulator battery 10. Moreover, the hand power tool 1 can record the reasons why active phases were terminated. In particular, data about the frequency of a switch-off based on error and warning messages can be recorded. The error and warning messages include, for example, the warning messages 17 on the part of the accumulator battery 10, messages from a secondary total discharge protection in the hand power tool 1, or an overload protection. A non-volatile data memory 18 can be provided in the accumulator battery 10, in which data collected on the part of the hand power tool 1 can be stored. After an operating cycle and/or an active phase, the hand power tool 1 transmits the data via the data interface 9 to the accumulator battery 10 for storage.

The hand power tool 1 may have an electrical buffer, which guarantees an operation of the data interface 9, if the accumulator battery 10 interrupts the power supply via the current interface 12. Alternatively, a second current interface can be provided, which the accumulator battery 10 switches off in a time-delayed manner after the first current interface is switched off. The second current interface permits only comparatively low power consumption and is indeed not designed for operating the drive of the hand power tool 1, but for operating the data interface 9.

The following describes an example of the operation of a system of a hand power tool 1 and an accumulator battery 10. After a user actuates the system switch 2, the hand power tool 1 transmits the maximum permissible duration T and, if applicable, additional ratings of the hand power tool 1 to the accumulator battery 10. For this purpose, the ratings are read out of the memory 20. Afterwards, the drive train and the motor 4 can be activated. Parallel operation of the drive and the data interface 9 are preferably avoided in order to guarantee malfunction-free data transmission. The motor 4 is in operation for an active phase.

The accumulator battery 10 is able to check the transmitted maximum permissible duration T and the additional ratings. If this duration and the ratings exceed the maximum values of the accumulator battery 10, the values are correspondingly limited. The total discharge protection 15 of the accumulator battery 10 will be set up in accordance with the transmitted values and, as the case may be, any restricted values. During a power output of the accumulator battery 10 to the hand power tool 1, the total discharge protection 15 monitors, as described above, the terminal voltage and/or the individual cell voltages. If the voltage limit is exceeded for longer than the permissible duration T, the accumulator battery 10 sends the warning signal 17 and/or disconnects the power supply.

If the user continues to press the system switch 2 after an active phase or re-actuates the system switch 2 within a period of time T1, i.e., within an operating cycle, in one embodiment, there is no further communication between the hand power tool 1 and the accumulator battery 10. If the period of time T1 is exceeded, the hand power tool 1 can again transmit the maximum permissible duration and, if applicable, the further ratings.

During the operating cycle, the recording device 21 determines, for example, the power consumption, the number of active phases and operating duration. As soon as an operating cycle is concluded, i.e., the system switch 2 has not been actuated for the period of time T1, the data are transmitted to the accumulator battery 10 for storage.

If a warning message 17 appears during an active phase, the motor 4 will be switched off. The recording device 21 registers the warning message in a count register. Upon termination of the operating cycle or directly upon the appearance of the warning message, the count register can be transmitted to the accumulator battery for storage.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A control method for an accumulator battery, which includes an interface for communicating with a hand power tool and for supplying the hand power tool, comprising the steps of:
receiving characterizing data of the hand power tool and/or data about an operating process of the hand power tool via the interface.

2. The control method according to claim 1, wherein the characterizing data include a load profile of the hand power tool.

3. The control method according to claim 1, wherein characterizing data about a maximum permissible duration for which a voltage limit of the accumulator battery and/or of individual cells of the accumulator battery may be fallen short of are received via the interface and if a total discharge protection of the accumulator battery determines that the voltage limit has been fallen short of longer than the maximum permissible duration, a warning signal is output via the interface and/or a power supply via the interface is interrupted.

4. A control method for a hand power tool, which includes an interface for communicating with an accumulator battery and for supplying from the accumulator battery, comprising the steps of:
outputting characterizing data of the hand power tool and/or data about an operating process of the hand power tool via the interface.

5. The control method according to claim 4, wherein characterizing data about a maximum permissible duration for which a voltage limit of the accumulator battery may be fallen short of are output via the interface and if a warning signal of a total discharge protection that the voltage limit has been fallen short of longer than the maximum permissible duration is received via the interface, a motor of the hand power tool is switched off.

6. The control method according to claim 5, wherein the characterizing data are read out of a permanent memory of the hand power tool.

7. The control method according to claim 4, wherein the characterizing data are output if a system switch of the hand power tool is not actuated for longer than a predetermined period of time.

8. The control method according to claim 4, wherein during a transmission of the characterizing data, a motor of the hand power tool is deactivated.

9. The control method according to claim 5, wherein the characterizing data contain a default for the voltage limit.

10. The control method according to claim 4, wherein a recording device of the hand power tool logs an operation of the hand power tool and transfers data of the logged operation to the accumulator battery for storage in the accumulator battery.

11. The control method according to claim 10, wherein the data are transmitted if a system switch is not actuated for longer than a predetermined period of time.

12. A control method for a system of a hand power tool and an accumulator battery, wherein the hand power tool is connectable to the accumulator battery via a current interface for supplying the hand power tool, and the hand power tool includes a data interface for communicating with the accumulator battery, comprising the steps of:
transmitting characterizing data of the hand power tool to the accumulator battery and/or data about an operating process of the hand power tool.

13. An accumulator battery for a hand power tool, which includes an interface for communicating with the hand power tool and for supplying the hand power tool, comprising:
a total discharge protection for monitoring a total discharge in response to characteristic data of the hand power tool transmitted by the hand power tool and/or a data memory for storing data about an operating process of the hand power tool which are transmitted by the hand power tool.

14. A power tool system, comprising:
a hand power tool;
an accumulator battery; and
an interface for communication between the hand power tool and the accumulator battery, wherein characterizing data of the hand power tool and/or data about an operating process of the hand power tool is communicable from the hand power tool to the accumulator battery via the interface.
